(19) United States
(12) Patent Application Publication
(10) Pub. No.: US 2012/0260259 A1
(43) Pub. Date: Oct. 11, 2012

(54) RESOURCE CONSUMPTION WITH ENHANCED REQUIREMENT-CAPABILITY DEFINITIONS

(75) Inventors: Srivatsan Parthasarathy, Seattle, WA (US); Ashvinkumar Sanghvi, Sammamish, WA (US); James Finnigan, Redmond, WA (US); Anders Vinberg, Kirkland, WA (US)

(73) Assignee: MICROSOFT CORPORATION, Redmond, WA (US)

(21) Appl. No.: 13/080,855

(22) Filed: Apr. 6, 2011

(51) Int. Cl. G06F 9/46

(52) U.S. Cl. 718/104

(57) ABSTRACT

Enhanced requirement-capability definitions are employed for resource consumption and allocation. Business requirements can be specified with respect to content to be hosted, and a decision can be made as to whether, and how, to allocate resources for the content based on the business requirements and resource capabilities. Capability profiles can also be employed to hide underlying resource details while still providing information about resource capabilities.

### BACKGROUND

Virtual machine technology facilitates increased physical resource utilization as well as agile machine provisioning, among other things. Traditionally, software applications are tightly coupled to physical servers on which they run. Virtual machine technology provides a layer of abstraction between the software applications as well as physical hardware and enables provisioning of multiple virtual machines on a single physical server (a.k.a., host), for example. As a result, workloads can be consolidated to improve physical asset utilization, and machines can be rapidly deployed and decommissioned, as needed.

A virtual machine (VM) is a piece of software that emulates a physical computer utilizing a virtual hard disk (VHD), among other things. A VHD is a physical hard disk analogue for a virtual machine. Accordingly, the VHD can include like representations for data and structural elements, such as files and folders. An operating system (OS) (a.k.a. guest operating system) can be installed on the VHD. Further, one or more applications can be installed on the VHD, and the OS can support execution of the one or more applications with respect to the virtual machine.

Placing a VM on a host machine involves allocating resources for the VM in light of competition from other VMs. The primary goal of placement is to ensure that VMs are provided with requisite resources to operate. In one implementation, slot allocation, the average amount of resources a VM consumes is determined, and host capacity is divided to determine a fixed number of slots. Each VM is then placed in a single slot regardless of actual resource usage. Alternatively, a more computationally intense approach can be employed, wherein actual resource requirements are provided for a VM and used for placement. Such requirements include a number of central processing units (CPUs), amount of memory, and connectivity needs (e.g., network I/O, storage I/O). Acquired resource requirements are subsequently employed to allocate required hardware resources automatically.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to facilitating consumption and allocation of computing resources with expanded requirement-capability definitions. Content can be associated with high-level/abstract business requirements. Resource allocation can be performed as a function of such business requirements and resource capabilities. In addition, a capability profile can be supplied to aid specification and enable validation of the business requirements prior to allocation. Furthermore, the business requirements can be mapped to provider-independent claims.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates resource consumption and allocation.

FIG. 2 is a block diagram of system that facilitates resource consumption and allocation including one or more capability profiles.

FIG. 3 is a block diagram of a system that facilitates resource consumption and allocation employing claims.

FIG. 4 is a flow chart diagram of a method of resource allocation.

FIG. 5 is a flow chart diagram of a method of resource consumption.

FIG. 6 is a schematic block diagram illustrating a suitable operating environment for aspects of the subject disclosure.

### DETAILED DESCRIPTION

Details below are generally directed toward resource consumption and allocation based on enhanced requirement and capability definitions. Conventionally, consumption and allocation have been based on low-level expressions of hardware requirements and capabilities including the number of central processing units, amount of memory and network input/output. Here, definitions of requirements and capabilities are extended to allow higher-level/abstract concepts, such as business requirements, to govern consumption and allocation of resources. Among other things, such technology enables movement away from a hardware-purchasing model and toward a consumption model. In furtherance thereof, capability profiles can also be employed to hide underlying resource details while still providing information about resource capabilities. Additionally, requirements can be captured as claims to allow resources to be allocated and reallocated independent of a provider, or in other words of particular management entities and/or supporting infrastructures, for instance.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

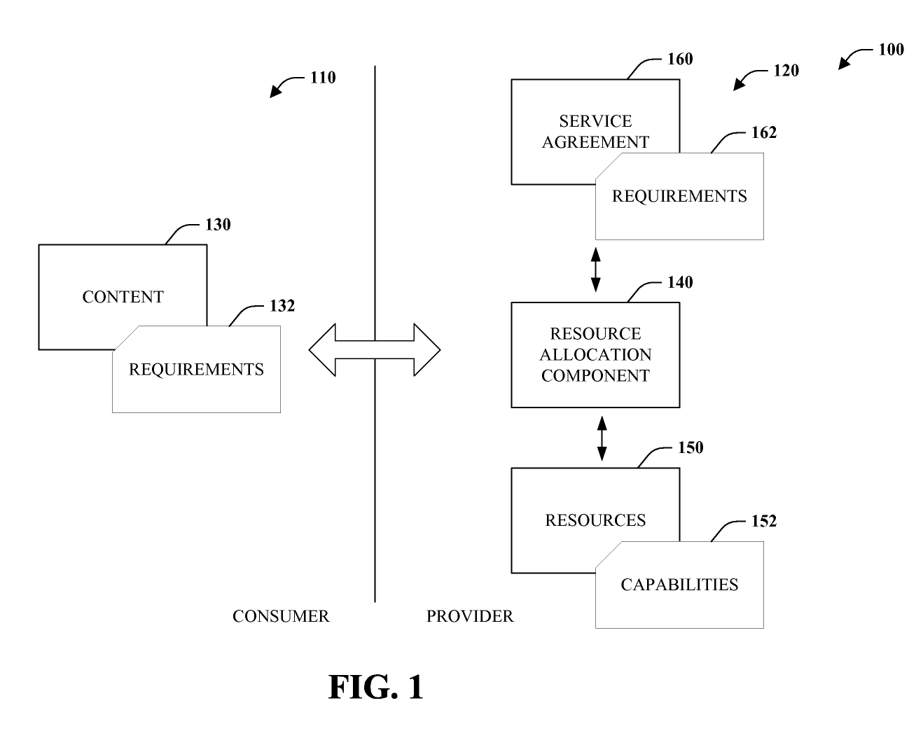

Referring initially to FIG. 1, illustrated is system 100 that facilitates resource consumption and allocation. The system 100 is divided by a vertical line into two distinct sides—consumer 110 and communicatively coupled provider 120. The consumer 110 supplies content 130 for external hosting. The provider 120 manages a plurality of computing resources 150 (a.k.a., resources 150) (e.g., physical and virtual computer system components) that can be employed to host the content 130. In accordance with one embodiment, the provider 120 can correspond to a hosting service and the consumer 110 can correspond to an entity (e.g., individual, organization . . . ) that desires to employ the hosting services. Of course, the consumer 110 can also correspond to a hosting service seeking additional resources from another provider 120 hosting service, among other things.

The content 130 supplied by the consumer 110 can include data, computer programs, or services, among other things. By way of example, and not limitation, the content 130 can be a virtual machine (VM) (seeking a virtualization host), a database management system (seeking a server host), or a website (desiring a web server host). Furthermore, the content 130 can include, or be associated with, a set of one or more requirements 132, or in other words, business requirements, provided by a consumer entity such as a programmer or administrator, for instance, that specify inclusive and/or exclusive constraints with respect to hosting. Unlike conventional constraints, the requirements 132 enable details regarding desired resource needs to be specified at a high-level rather than being concerned with low-level details of a particular hardware infrastructure (e.g., number of CPUs, amount of memory . . . ). Stated differently, the requirements 132 can be abstract requirements that do not deal with underlying hardware specifics.

By way of example, a requirement 132 can specify high-level/abstract constraints regarding connectivity, isolation, consumption level, or fault domains, among others. Connectivity requirements can pertain to connectivity relationships such as whether two or more applications communicate over a single network, for instance. Isolation requirements concern separation or isolation of hosted content with respect to physical systems. For example, an isolation requirement can specify that the content 130 be stored on different physical hardware than a competitor's content. Further, portions of content can be isolated from other portions for to facilitate error recovery, for instance. Consumption can concern an acceptable level of resource consumption. Since the resources 150 can scale easily, the content 130 can be constrained to consume a set amount of resources. Fault domains pertain to availability. For example, more than “N” servers or rack routers will go down at a time for various events. The concept can expand to failures of shared infrastructure or even geographies. There is a multitude of other exemplary requirements 132 including support for a particular security level or firewall, among other things.

Furthermore, the requirements 132 can be directed toward various layers, or tiers, of a resource stack. On top of a physical storage mechanism (e.g., flash) there are various host servers, for example. A compute fabric can reside on top of the host servers comprising a collection of computing resources including the host servers. Furthermore, the next layer can be an abstraction over the compute fabric such as a private cloud. As well, there can be multiple private clouds and public clouds, for instance, which form part of a provider infrastructure, or resource stack. Regardless of the particulars of a stack, requirements 132 can be specified with respect to one or more layers. For example, a requirement can specify that resources be located on a particular cloud or fabric.

Still further, the requirements 132 can be hierarchical. Accordingly, the requirements 132 can specify that resources be located on a cloud that is not shared with other particular consumers and the compute fabric comprising the cloud is located in a specific geographical area (e.g., United States), and the underlying storage used is flash, for example. In one embodiment, such hierarchical requirements can be specified as layers of name-value pairs, in an extensible markup language (XML) or the like, for instance. Of course, various other formats can also be employed as will be appreciated by those of skill in the art.

Still further yet, the requirements 132 can be hard or soft requirements. A hard requirement is requirement that must be met. By contrast, a soft requirement means the requirement should be met. Violating a hard requirement can result in a failure to deploy, for example. Violation of a soft requirement can result in a warning. In other words, a soft requirement is less stringent and more flexible than a hard requirement.

Requirements can also be either value or range requirements. A value requirement is a requirement that is met by a specific value (e.g., number of CPUs). A range requirement allows for a range of situations to meet a requirement. For instance, host storage capacity can be required to be within some range as opposed to a hard number. Similar to the hard and soft requirements, a value requirement is stricter than the range requirement.

Additional requirements can reside on the provider 120. More specifically, service level agreement 160 between a consumer and provider can supply provider requirements 162. For example, a service level agreement (SLA) 160, and associated requirements 162 capturing terms of the service level agreement 160, can specify various requirements or constraints such as but not limited to the use or exclusion of particular resources and/or extents of resources (e.g., resource cap). In other words, the provider requirements 162 can define a set of allowable resources for a particular consumer or organization, and consumer requirements 132 can further restrict resources within the set.

The provider 120 also includes resource allocation component 140 configured to allocate resources 150 for the content 130 as a function of the consumer requirements 132, provider requirements 162, and capabilities 152 of the resources 150. More particularly, the resource allocation component 140 can compare the consumer requirements 132 and the provider requirements 162 with the capabilities 152, wherein the capabilities 152 identify currently available and supported resources (e.g., available capacity in view of currently utilized resources). If the total set of requirements can be satisfied by the capabilities 152, the resource allocation component 140 can allocate resources 150 for the content 130. Subsequently, the content 130 can be hosted, for example, by the resources 150. On the other hand, if the total set of requirements cannot be satisfied based on the capabilities, the resource allocation component 140 can reject a request for resources.

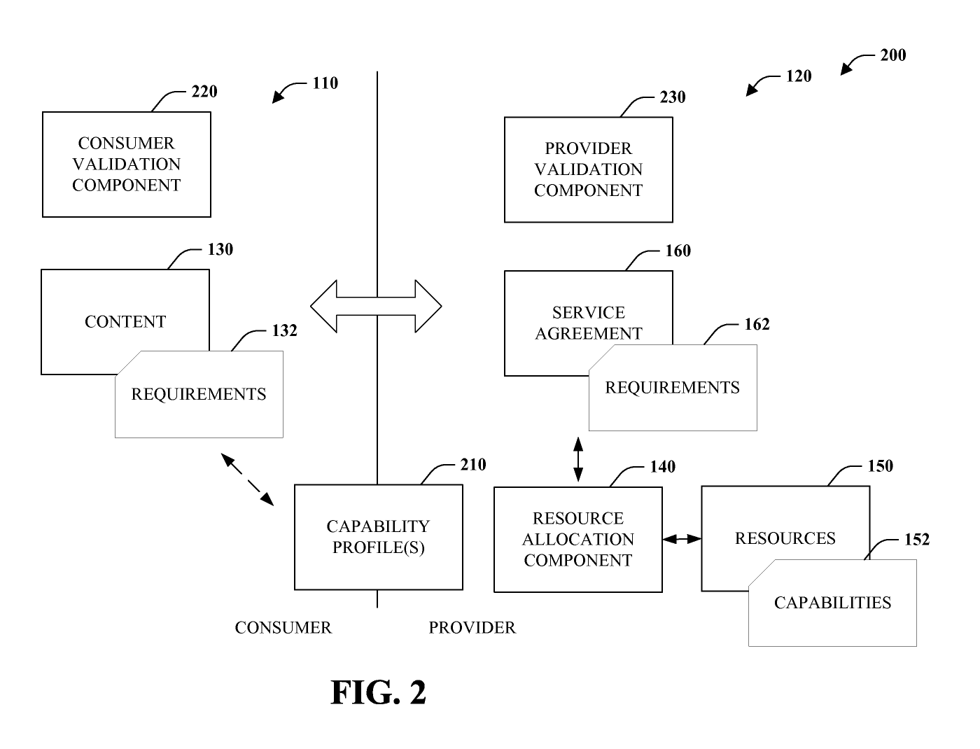

Turning attention to FIG. 2, system 200 that facilitates resource consumption and allocation is illustrated. Similar to system 100 of FIG. 1, the system 200 includes the consumer 110 comprising the content 130 and associated requirements 132, and the provider 120 comprising the service level agreement 160 and associated requirements 162, resource allocation component 140, as well as the resources 150 and corresponding capabilities 152. In brief, the resource allocation component 140 can provide resources for the content 130 as a function of consumer requirements 132, provider requirements 162, and available capabilities 152. Additionally, the system 200 includes one or more capability profiles 210.

The one or more capability profiles 210 identify sets of capabilities that a consumer 110 is allowed to use. Generally, it may not be desirable for the provider 120 to expose specifics of the underlying resources 150 to consumers for a number of reasons, including allowing the infrastructure to be changed easily. However, it is also desirable to provide consumers 110 with an indication of what is enabled by the resources 150. In fact, different allowances can be set up based on the service level agreement that is negotiated between a consumer 110 and a provider 120. The one or more capability profiles 210 provide information about supported functionality without revealing details concerning the underlying resources 150, or infrastructure, of a provider 120. More particularly, the one or more capability profiles 210 provide specific configurations against which consumer requirements 132 can be specified. For example, a capability profile can identify a range of CPUs and whether high availability virtual machines are available, among other things. A consumer can either chose from these specific configurations or choose any number of CPUs in this range, use high availability VMs or not. Essentially an individual can go down the list of characteristics and state which capabilities that content 130 will use as requirements 132.

Further, the requirements 132 associated with content 130 can be validated against the capability profile. More specifically, consumer validation component 220 can be configured to validate the requirements 132 against a linked or otherwise associated capability profile. If the consumer validation component 220 determines that the requirements 132 are valid, or in other words are consistent with a linked capability profile, a request can be made for resources with a high degree of confidence that the provider 120 will supply the requisite resources. However, if the consumer validation component 220 determines the requirements 132 are invalid in view of a linked capability profile, a message can be provided indicating as much to allow modification of the requirements 132, for instance.

Provider validation component 230 can be configured to perform the same function as the consumer validation component 220 except for the provider 120. The provider validation component 230 can therefore provide an extra layer of validation against invalid requirements or replace the consumer validation component 220. Additionally or alternatively, the provider validation component 230 can be configured to validate the provider-side business requirements 162 against a capability profile corresponding to particular content prior to processing by the resource allocation component 140.

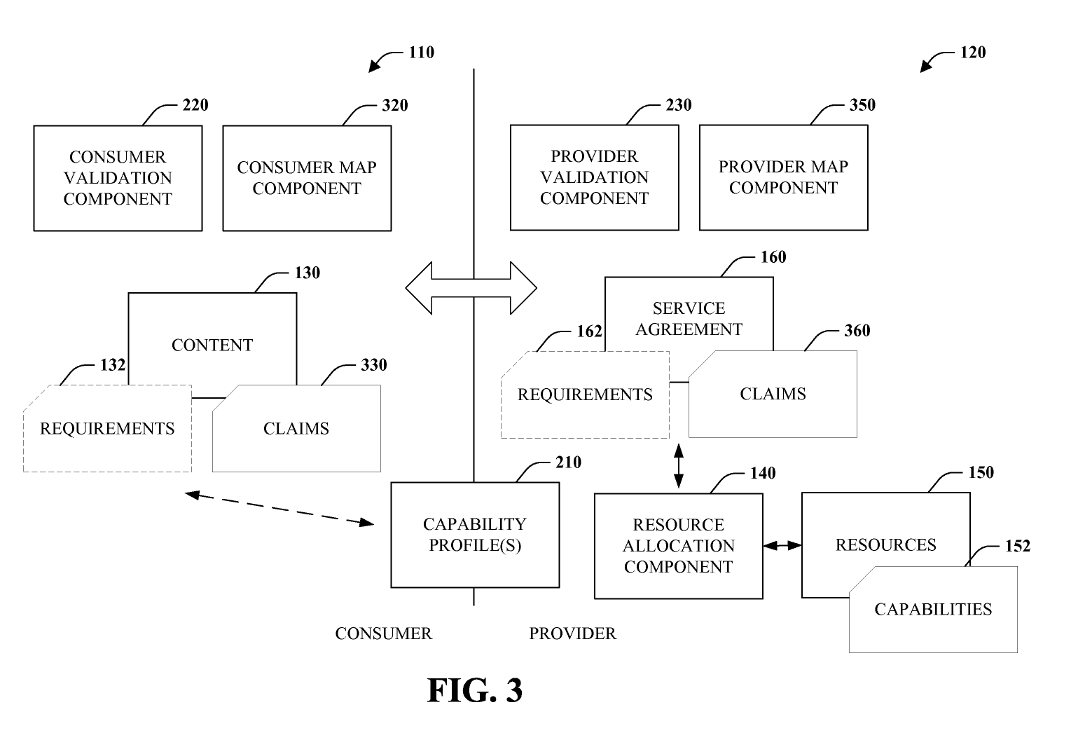

FIG. 3 depicts system 300 that facilitates consumption and allocation of resources. In addition to the functionality described above with respect to systems 100 and 200 of FIGS. 2 and 3, respectively, the system 300 includes consumer map component 320 and provider map component 350. The consumer map component 320 is configured to map consumer requirements 132 to provider-independent claims 330. Similarly, the provider map component 350 is configured to map provider requirements 162 to claims 360. Claims are a provider-independent or standardized manner of expressing restrictions. For example, consider a scenario where various consumers and providers come together from different companies, organizations, etc. There are bound to be provider differences with respect to at least infrastructure details and manners of interacting. Absent some standard, effective communication across providers and associated infrastructures is difficult, if not impossible. In furtherance thereof, the map components can be configured to map restrictions to a particular standard scheme and/or set of tags (e.g., content metadata tags).

The resource allocation component 140 of a provider 120 can extract claims associated with particular content and accurately interpret the claims as constraints with respect the resources 150. In accordance with one aspect, the capabilities can be expressed in a similar claim format, for example including tags, to facilitate matching of requirements and capabilities. Alternatively, the resource allocation component 140, for example by way of a sub-component (not shown), can transform the claims into a locally comprehendible format. Regardless of implementation detail, restrictions associated with particular content can be communicated and understood amongst different providers, infrastructures, businesses, organizations, etc.

Furthermore, tagging, or a functionally equivalent scheme, can aid understanding of structures and relationships and ultimately enhance resource allocation. For example, consider content that does not comprise sensitive data but interacts with other content that does include sensitive data. If content is tagged with appropriate tags, the resource allocation component 140 can determine or infer that mechanisms should be employed which protect the sensitive data.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the resource allocation component 140 can employ such mechanisms to infer from incomplete information whether a resources can be allocated to support particular content and associated requirements as well as which resources to allocate.

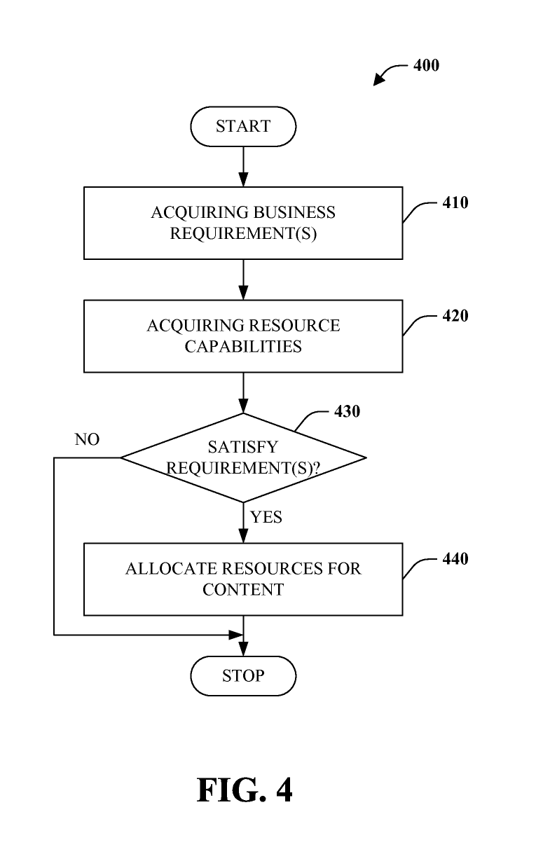

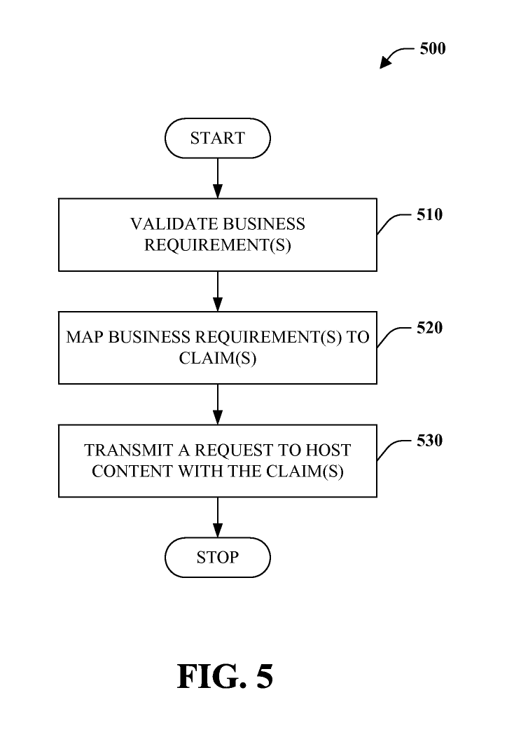

In view of the exemplary systems described supra, methodologies that may be implemented in accordance with the disclosed subject matter will be better appreciated with reference to the flow charts of FIGS. 4-5. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 4, a method 400 of resource allocation is illustrated. At reference numeral 410, one or more high-level, or business, requirements are acquired. For example, an abstract requirement specifying a particular connectivity between nodes can be received. At numeral 420, resource capabilities are acquired corresponding to a currently available infrastructure. At reference numeral 430, a determination is made as to whether resource capabilities can satisfy the one or more requirements. If not (“NO”), the method 400 can simply terminate unsuccessfully. Alternatively, if the capabilities can satisfy the one or more requirements (“YES”), the method 400 proceeds to numeral 440 where resources are allocated for content associated with the requirements.

In accordance with one embodiment, requirements and capabilities can be represented as claims, wherein claims are provider independent. In other words, not only do claims abstract away details of a particular provider's underlying hardware but also differences amongst providers (e.g., management entities, vendors . . . ) and associated infrastructures. As a result, a federated resource model is facilitated. Otherwise, the method 400 can operate similarly. For instance, claims associated with content and resources can be compared to determine if resources are available that can successfully host the content. If so, the resources are allocated, otherwise they are not.

FIG. 5 is a flow chart diagram of a method 500 of resource consumption. At reference numeral 510, one or more business requirements can be validated, for example, against an associated capability profile. In other words, it can be determined that the one or more business requirements are supported by, or consistent with, a set of capabilities provided in a profile. At numeral 520, the validated business requirement(s) are mapped to infrastructure independent claim(s). At numeral 530, a request is transmitted, with the claim(s), to a resource provider to host content. Subsequently, the content can be hosted, if the claims can be satisfied by provider/host resources (not shown).

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic - that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

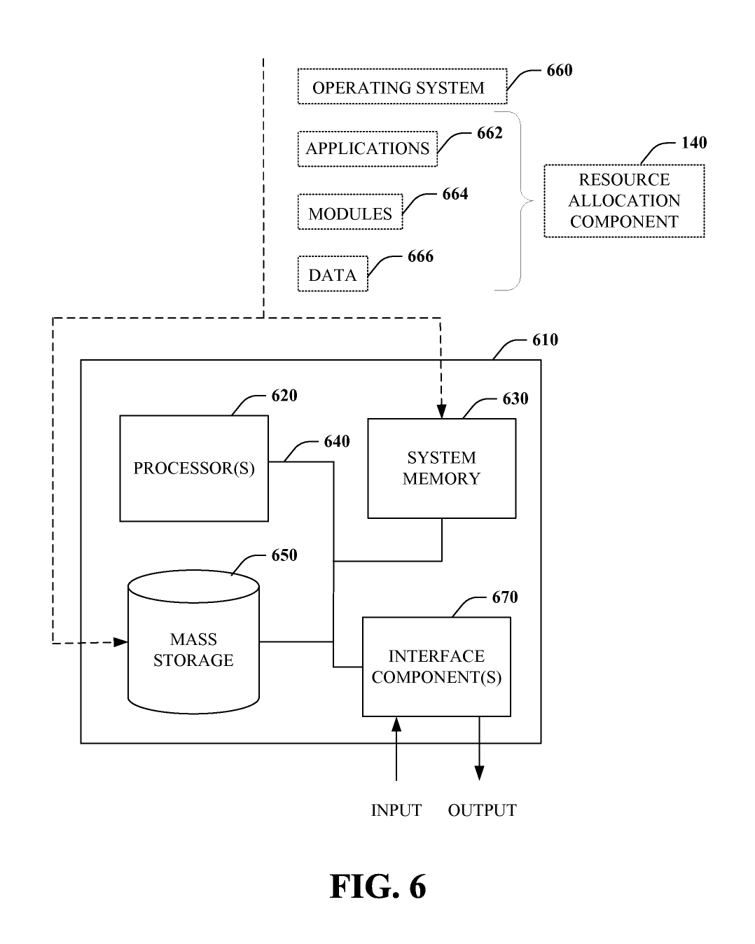

In order to provide a context for the claimed subject matter, FIG. 6 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 6, illustrated is an example general-purpose computer 610 or computing device (e.g., desktop, laptop, server, hand-held, programmable consumer or industrial electronics, set-top box, game system . . . ). The computer 610 includes one or more processor(s) 620, memory 630, system bus 640, mass storage 650, and one or more interface components 670. The system bus 640 communicatively couples at least the above system components. However, it is to be appreciated that in its simplest form the computer 610 can include one or more processors 620 coupled to memory 630 that execute various computer executable actions, instructions, and or components stored in memory 630.

The processor(s) 620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 620 may also be implemented as a combination of computing devices, for example a combination of a DSP and a microprocessor, a plurality of microprocessors, multi-core processors, one or more microprocessors in conjunction with a DSP core, or any other such configuration.

The computer 610 can include or otherwise interact with a variety of computer-readable media to facilitate control of the computer 610 to implement one or more aspects of the claimed subject matter. The computer-readable media can be any available media that can be accessed by the computer 610 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 610.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 630 and mass storage 650 are examples of computer-readable storage media. Depending on the exact configuration and type of computing device, memory 630 may be volatile (e.g., RAM), non-volatile (e.g., ROM, flash memory . . . ) or some combination of the two. By way of example, the basic input/output system (BIOS), including basic routines to transfer information between elements within the computer 610, such as during start-up, can be stored in nonvolatile memory, while volatile memory can act as external cache memory to facilitate processing by the processor(s) 620, among other things.

Mass storage 650 includes removable/non-removable, volatile/non-volatile computer storage media for storage of large amounts of data relative to the memory 630. For example, mass storage 650 includes, but is not limited to, one or more devices such as a magnetic or optical disk drive, floppy disk drive, flash memory, solid-state drive, or memory stick.

Memory 630 and mass storage 650 can include, or have stored therein, operating system 660, one or more applications 662, one or more program modules 664, and data 666. The operating system 660 acts to control and allocate resources of the computer 610. Applications 662 include one or both of system and application software and can exploit management of resources by the operating system 660 through program modules 664 and data 666 stored in memory 630 and/or mass storage 650 to perform one or more actions. Accordingly, applications 662 can turn a general-purpose computer 610 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example, and not limitation, the resource allocation component 140, or portions thereof, can be, or form part, of an application 662, and include one or more modules 664 and data 666 stored in memory and/or mass storage 650 whose functionality can be realized when executed by one or more processor(s) 620.

In accordance with one particular embodiment, the processor(s) 620 can correspond to a system on a chip (SOC) or like architecture including, or in other words integrating, both hardware and software on a single integrated circuit substrate. Here, the processor(s) 620 can include one or more processors as well as memory at least similar to processor(s) 620 and memory 630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the resource allocation component 140 and/or associated functionality can be embedded within hardware in a SOC architecture.

The computer 610 also includes one or more interface components 670 that are communicatively coupled to the system bus 640 and facilitate interaction with the computer 610. By way of example, the interface component 670 can be a port (e.g., serial, parallel, PCMCIA, USB, FireWire . . . ) or an interface card (e.g., sound, video . . . ) or the like. In one example implementation, the interface component 670 can be embodied as a user input/output interface to enable a user to enter commands and information into the computer 610 through one or more input devices (e.g., pointing device such as a mouse, trackball, stylus, touch pad, keyboard, microphone, joystick, game pad, satellite dish, scanner, camera, other computer . . . ). In another example implementation, the interface component 670 can be embodied as an output peripheral interface to supply output to displays (e.g., CRT, LCD, plasma . . . ), speakers, printers, and/or other computers, among other things. Still further yet, the interface component 670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A resource allocation method comprising:
employing at least one processor configured to execute computer-executable instructions stored in memory to perform the following acts:
allocating one or more computing resources to host content as a function of one or more business requirements of the content and one or more capabilities of the one or more computing resources.

2. The method of claim 1, allocating the one or more computing resources as a function of a service level agreement (SLA) between a consumer and a provider.

3. The method of claim 1 further comprises provisioning one or more capability profiles comprising a set of resource capabilities.

4. The method of claim 1 further comprises receiving identification of a capability profile against which the one or more business requirements are specified.

5. The method of claim 1 further comprises acquiring the one or more business requirements from a consumer specified in terms of one or more provider-independent claims.

6. The method of claim 1 further comprises validating the one or more business requirements against a capability profile.

7. The method of claim 1 further comprises mapping the one or more provider requirements to one or more provider-independent claims.

8. The method of claim 1, allocating the resources if one or more soft business requirements are satisfied by the one or more capabilities.

9. A system that facilitates resource allocation, comprising:
a processor coupled to a memory, the processor configured to execute the following computer-executable components stored in the memory:
a first component configured to allocate resources to host content as a function of one or more business requirements and one or more resource capabilities.

10. The system of claim 9, the one or more business requirements are specified in connection with a capability profile.

11. The system of claim 10 further comprising a second component configured to validate the one or more business requirements against the capability profile.

12. The system of claim 9, the one or more business requirements are a series of hierarchical name-value pairs.

13. The system of claim 9, the one or more business requirements are mapped to one or more provider-independent claims.

14. The system of claim 9, one of the one or more business requirements is specified with respect to particular resource tier.

15. The system of claim 9, one of the one or more business requirements is a connectivity requirement.

16. The system of claim 9, one of the one or more business requirements is an isolation requirement.

17. A computer-readable storage medium having data stored thereon that facilitates resource allocation, comprising:
one or more business requirements that specify one or more abstract constraints on hosting content.

18. The computer-readable storage medium of claim 17 further comprising identification of a capability profile.

19. The computer-readable storage medium of claim 17, the one or more business requirements are captured as provider-independent claims.

20. The computer-readable storage medium of claim 17, at least one of the one or more business requirements is a soft requirement.
